(19) United States
(12) Patent Application Publication
(10) Pub. No.: US 2004/0265679 A1
(43) Pub. Date: Dec. 30, 2004

(54) Electrode for fuel cell

(75) Inventor: Taizo Yamamoto, Tokyo (JP)

Correspondence Address: LORUSSO, LOUD & KELLY, 3137 Mount Vernon Avenue, Alexandria, VA, 22305, US

(73) Assignee: KABUSHIKIKAISHA EQUOS RESEARCH

(21) Appl. No.: 10/841,429

(22) Filed: May 10, 2004

(30) Foreign Application Priority Data
May 21, 2003 (JP) 2003-142858

(51) Int. Cl. H01M 4/94

(52) U.S. Cl. 429/44

(57) ABSTRACT

In an air-electrode-side catalyst layer of a fuel cell, the invention proposes a new method of preventing a polyelectrolyte material from being decomposed by radicals resulting from hydrogen that has penetrated an electrolyte membrane. According to the invention, the air-electrode-side catalyst layer is composed of a first catalyst layer on the side of the electrolyte membrane and a second catalyst layer on the side of a gas diffusion layer, and the first catalyst layer is higher in gas flow resistance than the second catalyst layer.

### INCORPORATION BY REFERENCE

The disclosure of Japanese Patent Application No. 2003-142858 filed on May 21, 2003 including the specification, drawings and abstract is incorporated herein by reference in its entirety.

### BACKGROUND OF THE INVENTION

1. Field of Invention

The invention relates to an improvement in an electrode for a fuel cell.

2. Description of Related Art

A fuel cell is constructed such that a solid-polyelectrolyte membrane is sandwiched between a fuel electrode (referred to also as a hydrogen electrode if hydrogen is used as the fuel electrode) and an air electrode (referred to also as an oxygen electrode because oxygen is a reactive gas, and referred to also as an oxidation electrode).

Fuel gas is supplied to the side of the fuel electrode (anode) and oxidation gas is supplied to the side of the air electrode, so that an electron is generated as an electrochemical reaction progresses. By taking the electron out into an external circuit, an electromotive force of the fuel cell constructed as described above is generated. That is, electric energy resulting from a series of electrochemical reactions can be fetched. In these electrochemical reactions, a hydrogen ion obtained in the fuel electrode (anode) moves in the form of a proton (H₃O⁺) toward the air electrode (cathode) in the electrolyte membrane containing water, and an electron obtained in the fuel electrode (anode) moves toward the air electrode (cathode) through an external load, reacts with oxygen in the oxidation gas (containing air), and produces water.

In the fuel cell constructed as described above, the air electrode is constructed such that a catalyst layer and a gas diffusion layer are sequentially laminated from the side of the electrolyte membrane. To ensure a higher output from the fuel cell, this catalyst layer is constructed with attention mainly focused on an enhancement of vacancy ratio or on an increase in pore diameter, for example, by using a structurally developed carbon black for carriage of a catalyst. This is because of the following reason. That is, since air contains only about 20% of oxygen which is required for the reactions, the catalyst layer must demonstrate a higher gas diffusibility to achieve a higher performance. Namely, a sufficient amount of air is supplied to the entire catalyst layer by making the gas flow resistance in the catalyst layer as low as possible.

However, a high gas diffusibility in this catalyst layer has the following problem. If the fuel cell is in an open circuit (OCV) state or a low-load operation state, hydrogen supplied to the side of the fuel electrode gradually permeates through the electrolyte membrane and reaches the side of the air electrode instead of being entirely consumed in generating electricity (this phenomenon is especially conspicuous if the electrolyte membrane is thin). If a metal ion such as Fe⁺⁺, however minute in amount, is contained as a contaminant in the electrodes or the membrane, the hydogen perocide, which is produced with the permeated hydrogen and the oxygen on the cathode catalyst, quite easily decomposes into a hydroxy radical (—OH) under an acid atmosphere. This radical is highly oxidative and thus may oxidize and decompose the polyelectrolyte material contained in the catalyst layer as well.

In the related art, therefore, decomposition of the polyelectrolyte material is prevented by capturing the metal ion serving as a catalyst for generation of hydrogen peroxide by using a chelating agent or by compounding an antioxidant into the metal ion (see Japanese Patent Application Laid-Open Publication No. 2003-86187, Japanese Patent Application Laid-Open Publication No. 2003-20308, Japanese Patent Application Laid-Open Publication No. 2002-343132, Japanese Patent Application Laid-Open Publication No. 2001-223015, and Japanese Patent Application Laid-Open Publication No. 2001-118591).

By adding the chelating agent or the antioxidant, the polyelectrolyte material is restrained from being decomposed.

However, while addition of those agents to a system of the fuel cell leads to an increase in cost, the stability of the agents themselves has not been confirmed.

### SUMMARY OF THE INVENTION

It is thus an object of the invention to provide a new measure to prevent a polyelectrolyte material from being decomposed by hydrogen peroxide.

As a result of repeatedly conducting committed studies on the prevention of decomposition of a polyelectrolyte material by hydrogen peroxide, the inventor has discovered “that radicals are generated exclusively on the side of a gas diffusion layer (i.e., in a region separated from an electrolyte membrane) in a catalyst layer” and reached the invention.

That is, the inventor has devised an electrode used for a fuel cell in accordance with an aspect of the invention. The fuel cell is constructed on the side of an air electrode thereof by laminating a catalyst layer and a gas diffusion layer on an electrolyte membrane. In this electrode, the catalyst layer is provided with a first catalyst layer on the side of the electrolyte membrane and a second catalyst layer on the side of the gas diffusion layer, and the first catalyst layer is higher in gas flow resistance than the second catalyst layer.

According to the electrode for the fuel cell constructed as described above, the first catalyst layer prevents movement of hydrogen that has penetrated the electrolyte membrane, and the hydrogen is oxidized in the first catalyst layer, so that the amount of the hydrogen that reaches the second catalyst layer on the side of the gas diffusion layer decreases. Since it has been proved that radicals are more likely to be generated on the side of the gas diffusion layer in the air-electrode-side catalyst layer, the above-mentioned structure can suppress generation of radicals in the air-electrode-side catalyst layer as a whole.

### BRIEF DESCRIPTION OF THE DRAWINGS

FIG. 1 is a schematic view of the construction of a fuel cell in accordance with a comparative example of the invention;

FIG. 2 is a chart showing generation of D₂O₂ and DF in the fuel cell of the comparative example;

FIG. 3 is a chart showing a relationship between gas flow resistance and generation of HF (i.e., generation of radicals) in an air-electrode-side catalyst layer;

FIG. 4 is a chart showing a relationship among a Pt-carrying carbon catalyst, a Pt-Black catalyst, and generation of HF (i.e., generation of radicals) in the air-electrode-side catalyst layer;

FIG. 5 is a schematic view of the construction of a fuel cell in accordance with an experimental example;

FIG. 6 is a chart showing a relationship regarding generation of HF (i.e., generation of radicals) in the fuel cell shown in FIG. 5;

FIG. 7 is a schematic view of the construction of a fuel cell in accordance with an embodiment;

FIG. 8 is a chart showing a relationship regarding generation of HF (i.e., generation of radicals) in the fuel cells of the embodiment and the comparative example; and

FIG. 9 is a chart showing operating characteristics (current-voltage characteristics) of the fuel cells of the embodiment and the comparative example.

### DESCRIPTION OF PREFERRED EMBODIMENT

This invention is based on the following characteristic in an air-electrode-side catalyst layer, which was found by the inventor as described already.

The characteristic is that radicals are generated exclusively on the side of a gas diffusion layer (i.e., in a region separated from an electrolyte membrane) in a catalyst layer.

This knowledge was obtained through an experiment that will be described below.

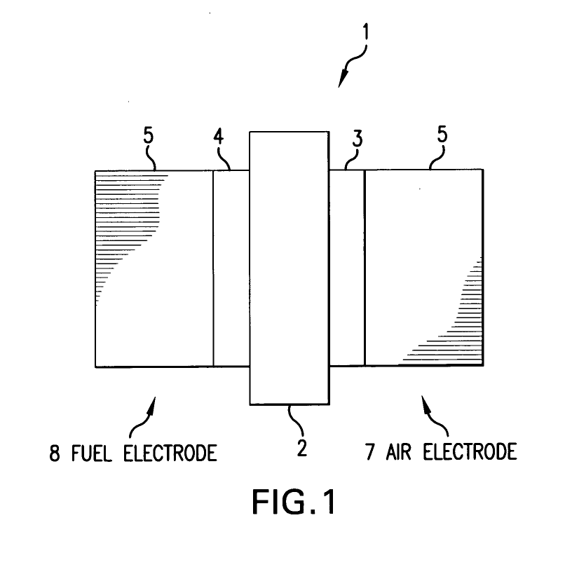

First of all, a fuel cell 1 of a comparative example shown in FIG. 1 was prepared. In this fuel cell 1, a solid-polyelectrolyte membrane 2 made of Nafion (Nafion 112® (proprietary name) manufactured by Du Pont Kabushiki Kaisha) is sandwiched between an air-electrode-side catalyst layer 3 and a fuel-electrode-side catalyst layer 4, and gas diffusion layers 5 are formed outside the catalyst layers 3 and 4 respectively. This fuel cell 1 is surrounded by a casing (not shown), which is provided with a hole through which air is delivered to and discharged from an air electrode 7 and with a hole through which hydrogen gas is delivered to and discharged from a fuel electrode 8.

The air-electrode-side catalyst layer 3 and the gas diffusion layers 5 were formed as follows.

First of all, the gas diffusion layers 5 are formed. A slurry, which is obtained by mixing a water-repellent carbon black (e.g., Denka Black® (trade name) manufactured by Denki Kagaku Kogyo Kabushiki Kaisha) and a PTFE dispersion (e.g., Polyflon D-1® (trade name) manufactured by Daikin Industries, Ltd.), is applied to both faces of a carbon cloth (e.g., GF-20-P7® (trade name) manufactured by Nippon Carbon Co., Ltd.). The carbon cloth is then baked in a nitrogen current at a temperature of 360° C. At this moment, it is appropriate that the content of PTFE in a layer obtained by applying the slurry be 20 to 50%, and that the amount of the slurry applied to each of the faces be 2 to 10 mg/cm².

A Pt-carrying carbon powder catalyst containing 40 to 60 wt % of Pt is then mixed with an electrolyte solution (a 5% Nafion® (proprietary name) solution manufactured by Aldrich Co.). The mixture is applied to a corresponding one of the gas diffusion layers by using a spray method, a screen printing method or the like, and then is dried, whereby the air-electrode-side catalyst layer 3 is obtained. It is preferable that the amount of the carried catalyst per unit area of the catalyst layer be 0.2 to 0.6 mg/cm².

The air-electrode-side catalyst layer 3 and a corresponding one of the gas diffusion layers 5 constitute the air electrode 7.

On the other hand, the fuel-electrode-side catalyst layer 4 was formed as follows. The Pt-carrying carbon powder catalyst containing 20 to 40 wt % of Pt is mixed with the electrolyte solution (the 5% Nafion® (proprietary name) solution manufactured by Aldrich Co.). The mixture is then applied to the other gas diffusion layer by using the spray method, the screen printing method, or the like, and then is dried, whereby the fuel-electrode-side catalyst layer 4 is obtained. It is preferable that the amount of the carried catalyst per unit area of the catalyst layer be 0.1 to 0.3 mg/cm².

The fuel-electrode-side catalyst layer 4 and the other gas diffusion layer 5 constitute the fuel electrode 8.

The solid-polyelectrolyte membrane 2 is sandwiched between the electrodes obtained as described above, namely, between the air electrode 7 and the fuel electrode 8. The solid-polyelectrolyte membrane 2 is then bonded to the electrodes by using a hot pressing method. It is preferable that a temperature of 120 to 160° C., a pressure of 30 to 100 kg/cm², and a pressing period of 1 to 5 minutes constitute a condition for hot pressing.

The fuel cell 1 shown in FIG. 1, which has been thus obtained, is activated by being sufficiently energized in advance. The temperature of a cell is then set as 80° C., and an excessive amount of dry N₂ gas is delivered to both the electrodes 7 and 8. The electrodes 7 and 8 are sufficiently dried, so that the fuel cell 1 is initialized in state. This is because of the purpose of preventing the amount of hydrogen penetrating the electrolyte membrane from fluctuating due to an initial difference in wet state of the electrolyte membrane 2. Thereafter, heavy hydrogen (80° C., humidified in a saturated state) is supplied to the side of the fuel electrode 8 at a rate of 0.03 L/min (a stoichiometric ratio 4 at 0.05 A/cm²), and air (at a room temperature and not humidified) is delivered at a rate of 0.32 L/min (a stoichiometric ratio 17 at 0.05 A/cm²), so that the fuel cell 1 is operated in an open circuit state. One end of a capillary made of glass is brought into contact with the air electrode 7, and the other end of the capillary is connected to a high-vacuum exhaust system and a mass spectrometer. A gas component in the vicinity of the air electrode 7, which has been sampled via the capillary, is identified by the mass spectrometer in situ.

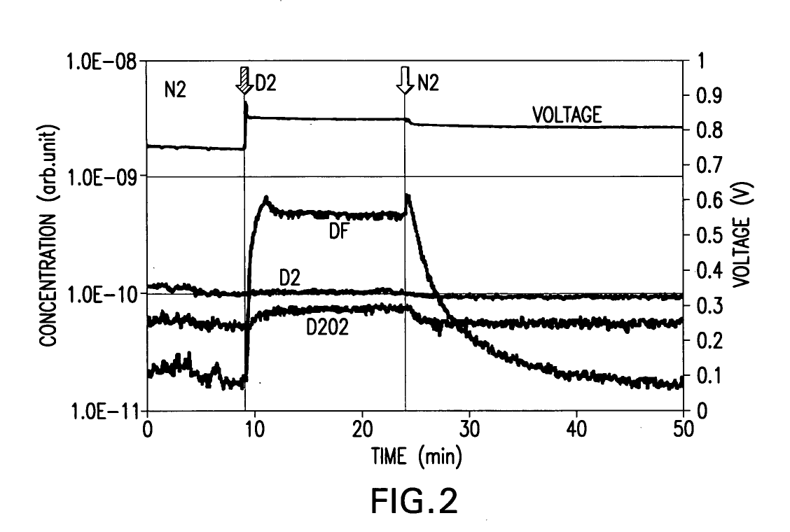

FIG. 2 shows a result of the identification. Referring to FIG. 2, an initialization stage lasts for the first ten minutes. Heavy hydrogen (D₂) gas was supplied to the side of the fuel electrode 8 ten minutes after the start of a measurement. As a result, heavy hydrogen peroxide (D₂O₂) and heavy hydrogen fluoride (DF) are increased in concentration. This is considered to be a phenomenon wherein heavy hydrogen that has passed through the electrolyte membrane 2 is oxidized in the air-electrode-side catalyst layer 3 and turns into heavy hydrogen peroxide, wherein the heavy hydrogen peroxide generates a radical (DH) under an acid atmosphere, and wherein the radical decomposes polyelectrolyte material in the catalyst layer 3 to generate heavy hydrogen fluoride.

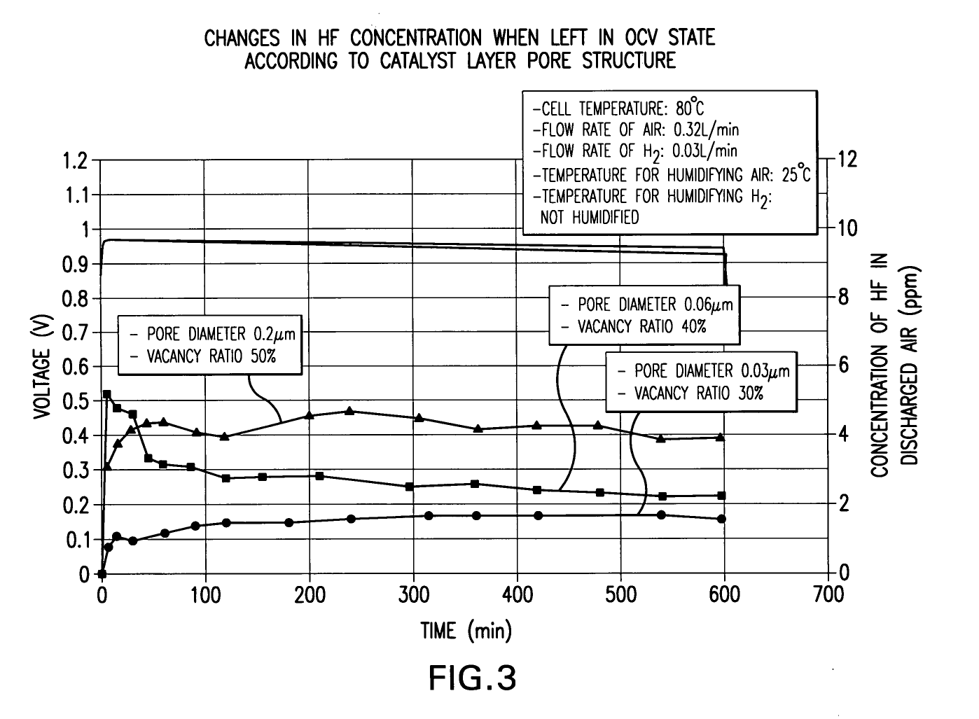

Next, as regards the fuel cell 1 shown in FIG. 1, the generation amount of hydrogen fluoride (HF) at the time of a change in pore structure of the air-electrode-side catalyst layer 3 was monitored. The result is shown in FIG. 3. Lines on the lower side of FIG. 3 indicate concentrations of HF. It is apparent from FIG. 3 that the concentration of HF increases with increases in vacancy ratio. That is, the amount of generation of a hydroxy radical increases as the catalyst layer 3 decreases in density and as the gas flow resistance thereof lowers.

This is considered to result from the fact that hydrogen that has passed through the electrolyte membrane 2 easily spreads all over a catalyst layer with a low gas flow resistance and thus makes it easy to generate hydrogen peroxide as a radical generation source.

It can be confirmed from the result shown in FIG. 3 “that the generation amount of hydrogen peroxide increases as the catalyst layer decreases in density (i.e., as the gas flow resistance decreases)” and “that the generation amount of hydrogen peroxide decreases as the catalyst layer increases in density (i.e., as the gas flow resistance increases).

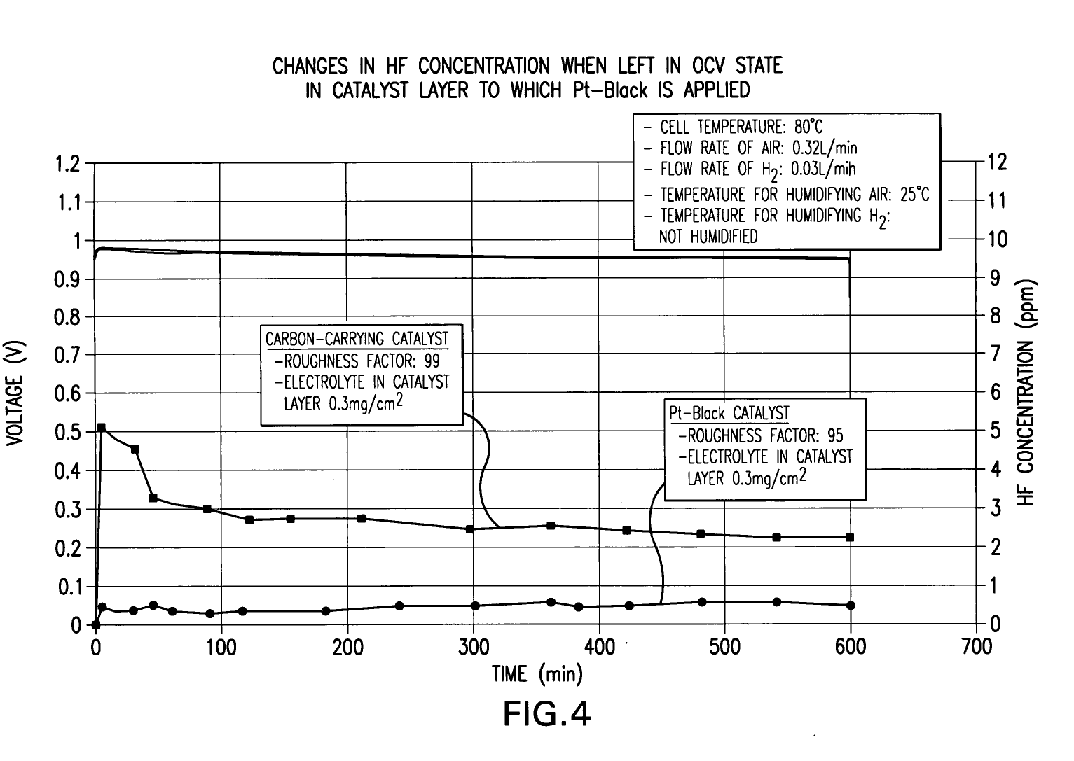

A condition for a measurement in FIG. 3 is apparent from the descriptions in the drawing. The output voltage of each of samples is slightly less than 1V Although the Pt-carrying carbon catalyst is used as the air-electrode-side catalyst layer 4 in the fuel cell 1 shown in FIG. 1, FIG. 4 shows how hydrogen fluoride is generated in an open circuit state with a Pt-Black catalyst used as the air-electrode-side catalyst layer 4 (with all the other manufacturing conditions remaining unchanged). The catalyst layer 4 having the Pt-carrying carbon catalyst and the catalyst layer 4 having the Pt-Black catalyst are equalized in roughness factor with each other.

It is apparent from the result shown in FIG. 4 that the generation amount of hydrogen fluoride significantly decreases in the case where the Pt-Black catalyst is employed. This is considered to result from the fact that oxygen molecules adsorbed on platinum are easily dissociated, that the oxygen molecules react with hydrogen that has passed through the electrolyte membrane 2 and produce nothing but water, and that hydrogen peroxide as a radical generation source is unlikely to be generated.

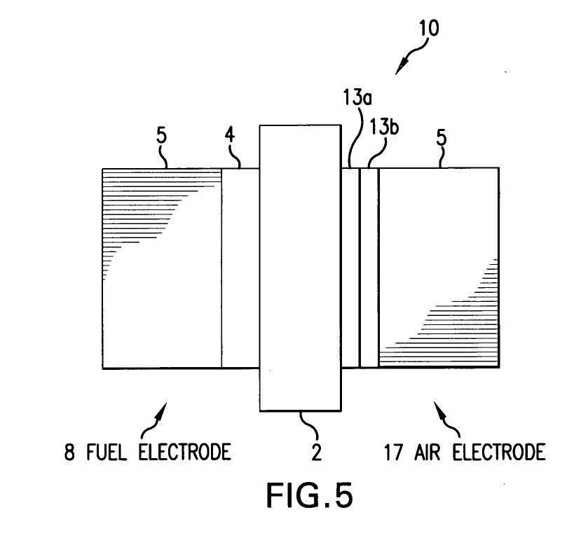

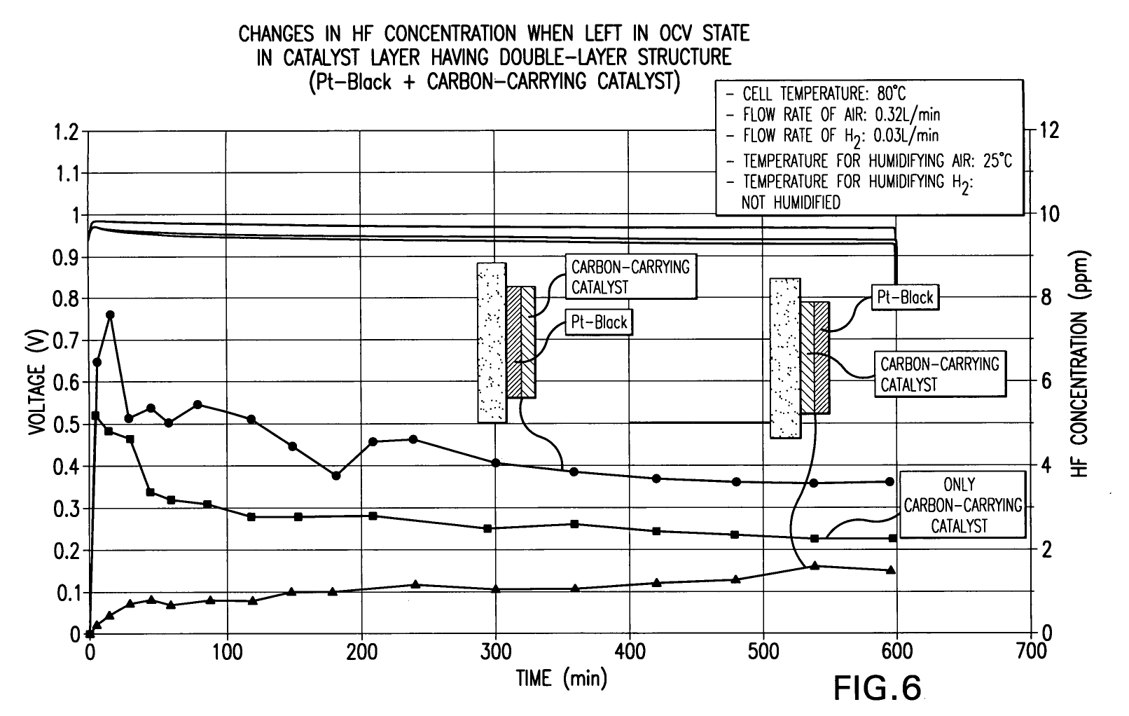

On the premise that the generation amount of hydrogen fluoride is smaller in the Pt-Black catalyst than in the Pt-carrying carbon catalyst as described already, as shown in FIG. 5, the air-electrode-side catalyst has a double-layer structure (a first catalyst layer 13a and a second catalyst layer 13b) with one layer made of the Pt-carrying carbon catalyst and the other made of the Pt-Black catalyst. Referring to FIG. 5, elements which are identical with those shown in FIG. 1 are denoted by the same reference symbols and will not be described hereinafter. FIG. 6 shows a result obtained by monitoring a generation amount of hydrogen fluoride when a fuel cell 10 having an air-electrode-side catalyst layer as described above is operated in an open circuit state.

It is apparent from the result shown in FIG. 6 that the generation amount of hydrogen fluoride significantly decreases if the Pt-Black catalyst layer is disposed on the side of the gas diffusion layers 5. In consideration of the fact that the generation amount of HF in the Pt-Black catalyst layer is small, the generation spot of radicals is estimated to be on the side of a gas diffusion layer in a catalyst layer.

A knowledge newly acquired by the inventor, namely, “that radicals are generated exclusively on the side of a gas diffusion layer (i.e., in a region separated from an electrolyte membrane) in a catalyst layer” can be confirmed from the results shown in FIGS. 4 and 6.

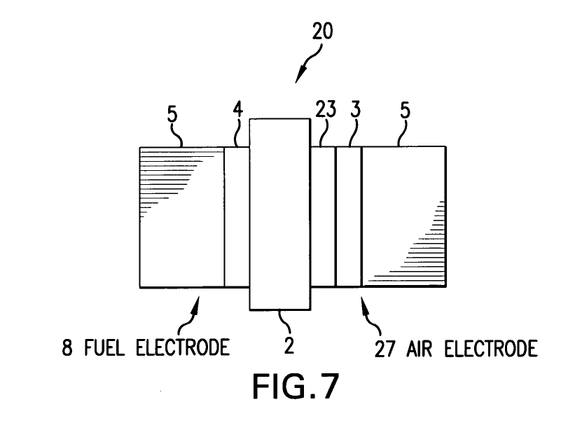

A condition for a measurement in FIG. 6 is apparent from the descriptions in the drawing. The output voltage of each of samples is slightly less than 1V FIG. 7 shows a fuel cell 20 of an embodiment of the invention. Referring to FIG. 7, elements which are identical with those shown in FIG. 1 are denoted by the same reference symbols and will not be described hereinafter.

In the fuel cell 20 of the embodiment, the air-electrode-side catalyst layer (second catalyst layer) 3 is formed on one of the gas diffusion layers 5 in the same manner as in FIG. 1 (with a membrane thickness of about 10 μm). Thereafter, a pore distribution of a powder material that is obtained by mixing a Pt-carrying carbon powder catalyst with an electrolyte and drying them is measured. Thereby a catalyst that is smaller in vacancy ratio and/or pore diameter and larger in gas flow resistance than the second catalyst layer 3 is selected in advance. This catalyst is mixed with an electrolyte solution. The mixture is applied to the second catalyst layer 3 by using the spray method, the screen printing method or the like, and then is dried, whereby a first catalyst layer 23 is formed (with a membrane thickness of about 2 to 5 μm). The first catalyst layer 23 is used as an air electrode 27. The first catalyst layer 23 is texturally higher in density and higher in gas flow resistance than the second catalyst layer 3. In the embodiment, the amount of the catalyst carried in the first catalyst layer 23 per unit area thereof is 0.01 to 0.2 mg/cm².

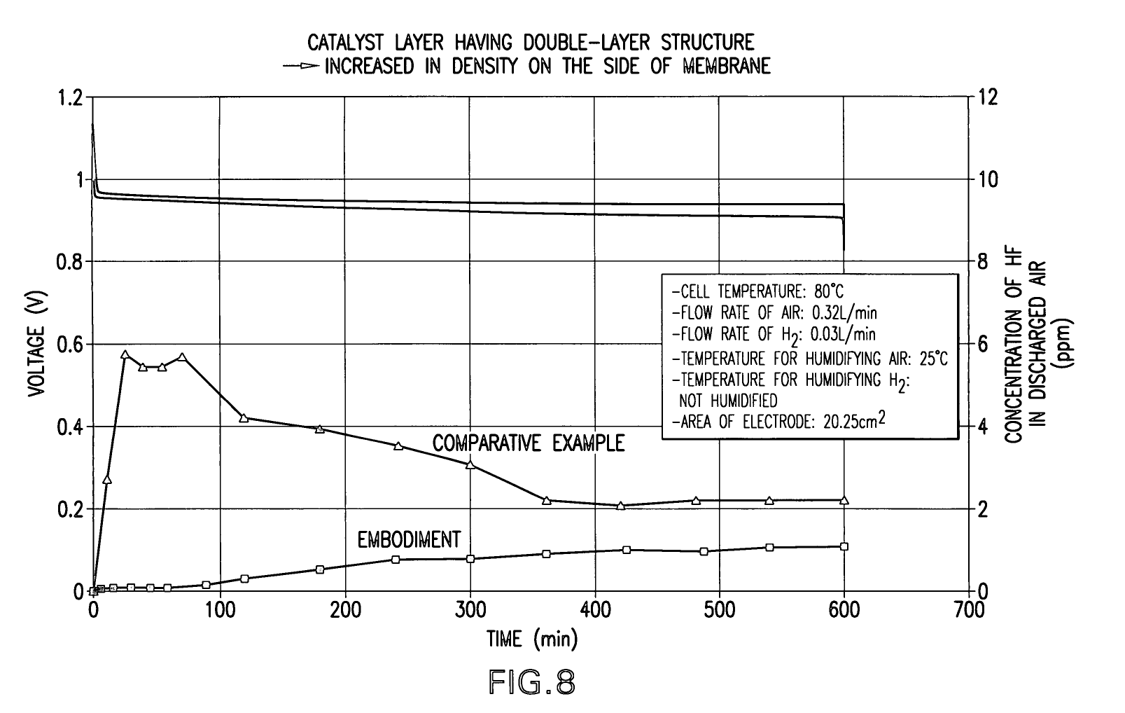

FIG. 8 shows a result obtained by monitoring a generation amount of hydrogen fluoride when the fuel cell 20 of the embodiment obtained as described above is operated in an open circuit state. As the comparative example, the generation amount of fluorine in the fuel cell 1 of FIG. 1 is demonstrated. A condition for a measurement in FIG. 8 is apparent from the descriptions in the drawing. The output voltage of each of samples is slightly less than 1V.

It is apparent from the result shown in FIG. 8 that the generation amount of hydrogen fluoride in the fuel cell 20 of the embodiment has decreased to about half of that of the comparative example even at the moment of equilibrium which is ten hours (600 minutes) after the start of a test. This is considered to result from the fact that hydrogen that has penetrated the electrolyte membrane 2 is prevented from moving in the first catalyst layer having a dense structure, that the absolute amount of hydrogen that reaches the second catalyst layer having a potential of generating radicals is small, and that the generation amount of hydrogen peroxide as a radical generation source is small in the catalyst layer as a whole.

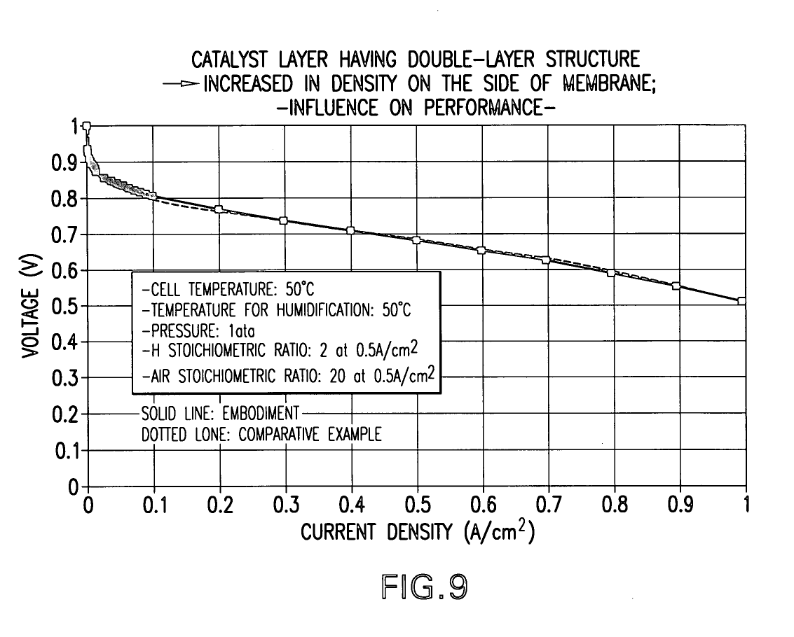

If a first layer having a high gas flow resistance is provided in the air-electrode-side catalyst layer, it is apprehended that the output characteristic of the fuel cell will deteriorate due to a decrease in diffusibility of air. However, as shown in FIG. 9, the fuel cell of the embodiment (FIG. 7) demonstrated substantially the same voltage-current characteristic as the fuel cell of the comparative example (FIG. 1).

That is, the fuel cell 20 of the embodiment can suppress generation of radicals while the operating characteristic thereof is maintained. Accordingly, the polyelectrolyte material is restrained from being decomposed, and a stable power generation performance is maintained.

In the example shown in FIG. 7, the air-electrode-side catalyst layer has a double-layer structure. However, this air-electrode-side catalyst layer may have a triple-layer structure or a multiple-layer structure composed of four or more layers. In this case, it is preferable that the gas flow resistance of the layers be sequentially reduced from the side of the electrolyte membrane toward the gas diffusion layer. Furthermore, it is also possible that the gas flow resistance in the air-electrode-side catalyst layer be gradually reduced from the side of the electrolyte membrane toward the gas diffusion layer.

The inventor has confirmed that more radicals are generated in a diffusion-layer-side region in the air-electrode-side catalyst layer. Accordingly, by concentratively providing a radical generation preventing agent in the region, the characteristic of the air-electrode-side catalyst layer can be effectively prevented from deteriorating. As the radical generation preventing agent, it is possible to use the chelating agent and antioxidant proposed in the aforementioned patent documents of the related art as well as the dense layer (see FIG. 3) and the Pt-Black catalyst (see FIG. 4).

As described hitherto, according to the aspect of the invention, the first catalyst layer on the side of the electrolyte membrane and the second catalyst layer on the side of the gas diffusion layer are provided as the air-electrode-side catalyst layer, and the first catalyst layer is higher in gas flow resistance than the second catalyst layer. Thereby, the first catalyst layer prevents movement of hydrogen that has permeated through the electrolyte membrane, and the amount of the hydrogen that is oxidized in the first catalyst layer and that reaches the second catalyst layer on the side of the gas diffusion layer decreases. Since it has been proved that radicals are more likely to be generated on the side of the gas diffusion layer in the air-electrode-side catalyst layer, the above-mentioned structure can suppress generation of radicals in the air-electrode-side catalyst layer as a whole. Accordingly, the polyelectrolyte material in the air-electrode-side catalyst layer is restrained from being decomposed, and the performance thereof is held stable.

According to another aspect of the invention, with a view to enhancing the gas flow resistance in the aforementioned aspect of the invention, the first catalyst layer is smaller in pore diameter than the second catalyst layer. This structure can suppress generation of radicals in the air-electrode-side catalyst layer as a whole.

Furthermore, according to still another aspect of the invention in which these fuel cell electrodes are applied to the fuel cell, the life of the fuel cell can be prolonged.

The invention is not at all limited to the embodiment and example described above. Various modifications are also included in the invention as long as they are easily devisable for those skilled in the art without departing from the scope defined by the claims.

1. An electrode used for a fuel cell which is constructed on the side of an air electrode thereof by laminating a catalyst layer and a gas diffusion layer on an electrolyte membrane, wherein the catalyst layer is provided with a first catalyst layer on the side of the electrolyte membrane and a second catalyst layer on the side of the gas diffusion layer, and the first catalyst layer is higher in gas flow resistance than the second catalyst layer.

2. The electrode used for a fuel cell according to claim 1, wherein the first catalyst layer is smaller in pore diameter than the second catalyst layer.

3. The electrode used for a fuel cell according to claim 1, wherein the first catalyst layer is smaller in vacancy ratio than the second catalyst layer.

4. A fuel cell provided with the electrode according to claim 1.
